(19) United States
(12) Patent Application Publication
(10) Pub. No.: US 2006/0010778 A1
(43) Pub. Date: Jan. 19, 2006

(54) Low flexural modulus pattern on extruded low-friction material

(75) Inventors: Eric Drozd, Farmington Hills, MI (US); Sean Scott, Walled Lake, MI (US); Jim Mistopoulos, Saline, MI (US)

Correspondence Address: Timothy E. Nauman;Fay, Sharpe, Fagan, Minnich & McKee, LLP, 7th Floor, 1100 Superior Avenue, Cleveland, OH, 44114-2518, US

(73) Assignee: Cooper Technology Services, LLC

(21) Appl. No.: 10/892,627

(22) Filed: Jul. 16, 2004

(51) Int. Cl. E05D 15/16

(52) U.S. Cl. 49/441

(57) ABSTRACT

A composite structure finds particular use as a weatherstrip on a motor vehicle. The weatherstrip includes a first material such as rubber, EPDM or thermoplastic that exhibits flexibility, and a second, hard, low friction material applied over portions of a surface of the rubber. In a preferred arrangement, the low friction material is coextruded with the first material in spaced rows that allow the weatherstrip to flex in regions where no second material is applied. An increased thickness of low friction material is applied thereby improving wear characteristics without impacting flexibility.

### BACKGROUND OF THE INVENTION

This application generally relates to a composite strip comprised of a first or flexible member formed from a first material and a second material having a desired hardness and applied on selected areas of the flexible member to maintain flexibility of the composite structure.

The composite structure finds particular application as a weatherstrip used in association with motor vehicles, such as a belt seal or glass run, or similar weatherstrip arrangement where contact with a window, and particularly in a region of a dynamic contact with the window, requires flexibility and a hard wear surface.

It is known to provide a generally U-shaped or C-shaped rigid channel in which a similarly contoured C-shaped extrusion is inserted, or where selected portions of the channel are coated with an elastomer to serve as a glass run. For example, a thermoplastic elastomer or EPDM is extruded onto the channel to form one or more flexible seal lips and on the base portion of the channel for wear purposes. The open region or cavity of the glass run receives and guides an edge of a window as the window is selectively raised and lowered relative to a vehicle door.

It is important to maintain flexibility of the composite structure, for example, where the weatherstrip is a glass run having sealing lips that flex inwardly from the outer terminal edges of the channel. A hard coating is typically applied to the flexible member such as an EPDM material, and the coating is adhesively secured to the EPDM or co-extruded therewith. The coating is usually applied over the entire surface of the EPDM and provides the desired wear characteristics of a low friction coating, although the flexibility of the structure is substantially reduced. That is, improved wear characteristics are achieved by applying a thicker coating, while the desired flexibility suggests that a thinner coat be applied. Thus, in the end, either wearability or durability is potentially compromised or sealability becomes an issue if the flexibility is sacrificed.

Conequently, a need exists for a composite structure or weatherstrip in which both of these goals are achieved without adversely impacting on performance characteristics, and that can be manufactured in an efficient and cost effective manner.

### SUMMARY OF THE INVENTION

A composite structure includes an elongated flexible member having a first surface, at least a portion of which is adapted for engagement with an associated motor vehicle window. A low-friction material is disposed in longitudinal rows on the first surface.

The longitudinal rows are preferably substantially parallel along the length of the flexible member.

The low-friction material extends outwardly from the first surface of the flexible member.

In a preferred embodiment, the low-friction material has a variable thickness and the individual rows are separated or segregated so that the flexible member is capable of selectively articulating along the segregated regions.

The low-friction material has a maximum thickness on the order of 0.250 mm.

A method of forming a weatherstrip comprises the steps of forming an elongated flexible member and extruding first and second rows of a low-friction material on a first surface of the flexible member.

The flexible member forming step preferably includes the step of extruding the flexible member.

A primary benefit of the invention is the ability to provide a hard surface that does not have the same drag characteristics as a rubber, and does not lose its flexiblity. The preferred weatherstrip allows increased thickness of the hard or rigid material without impacting the flexibility of the composite weatherstrip.

Alternating peaks and valleys where the peaks are a hard material and the valleys are the flexible first material provides durability and flexibility, respectively.

The center-to-center spacing of the peaks may vary, and likewise the height of the extruded peaks can also vary depending on the material used.

Yet another advantage of the invention relates to the ease in manufacturing the weatherstrip.

Still other features and benefits of the invention will become apparent to those skilled in the art upon reading and understanding the following description.

### BRIEF DESCRIPTION OF THE DRAWINGS

FIG. 1 is an elevational view of an automotive vehicle showing the general location of a composite strip such as a glass run channel and belt weatherstrip.

FIG. 2 is an enlarged elevational view of a glass run channel for a front door of the motor vehicle shown in FIG. 1.

FIGS. 3 and 4 are sectional views through a glass run.

FIG. 5 is an enlarged, cross-sectional view of a composite structure/weatherstrip incorporated in a glass run.

FIG. 6 is an enlarged view of the first surface of the composite structure/weatherstrip.

### DETAILED DESCRIPTION OF THE INVENTION

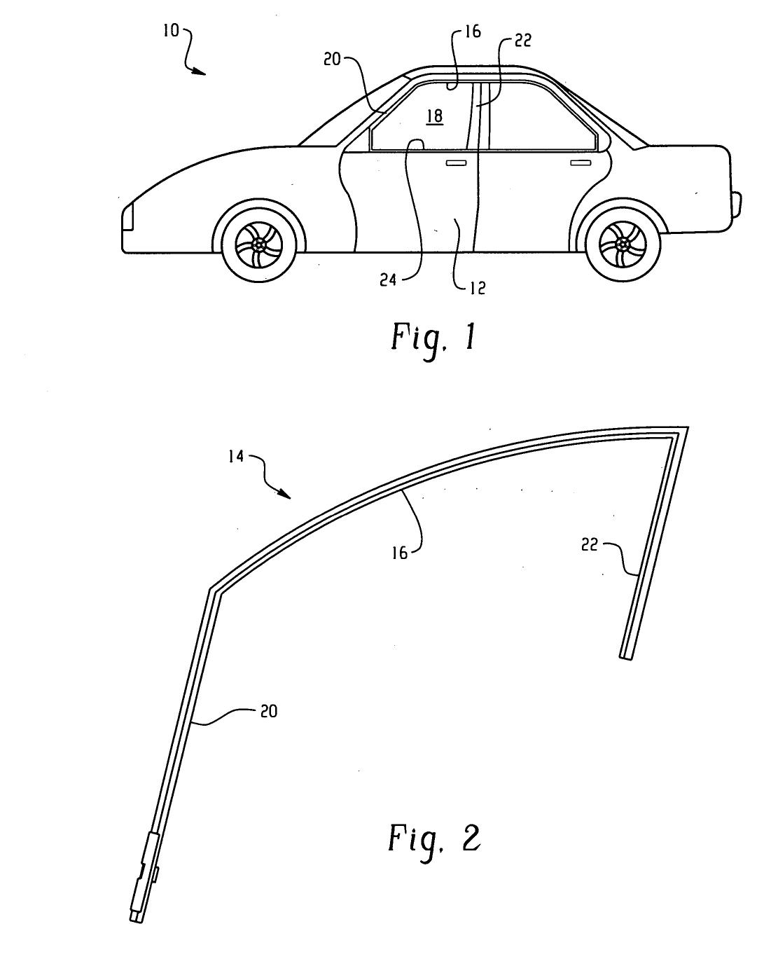

FIG. 1 is representative of a motor vehicle, such as automobile 10, that includes weatherstrips located at various locations on the vehicle. Known weatherstrips on a vehicle include door seals, window seals, sun-roof seals, window channel seals (i.e., glass runs), trunk seals, hood-to-cowl seals, etc. These weatherstrips are often composite structures and serve the purposes of sealing, aesthetics, trim and edge pieces, etc. These weatherstrips are formed in a variety of manners, for example, extrusion, molding, adhesives, fasteners, etc. It is also known to form the weatherstrip from different materials. For example, an elastomer such as EPDM is commonly used as a first or base material because of its resilient, elastic qualities, as well as the ease of manufacture by either extrusion or molding. It is also known, to provide a second material on the first material that has improved wear characteristics, i.e., is a hard material that provides a low-friction surface that bears against the window.

The vehicle 10 includes door 12 that is conventionally provided with a weatherseal assembly 14, comprised of a header portion 16 that seals along the upper edge of window 18, A and B pillar portions 20, 22, respectively, and belt seal 24. Of course, the other seals described above are also included in a motor vehicle, but for purposes of brevity are not described in greater detail herein. As shown in FIG. 2, the weatherseal assembly/glass run extends below the belt line or belt seal area 24 of the door and aids in guiding the window as the window is opened and closed relative to the door. As noted above, one example of a glass run includes a C-shaped or U-shaped channel, typically a metal channel provided for strength or rigidity. It is common to employ a similarly shaped elastomeric member (not shown) with flexible lips extending inwardly from the open ends of the channel shape that receive the window. U.S. Pat. No. 5,217,786 (the details of which are incorporated herein by reference) illustrates such an arrangement. Still other glass run configurations are well known in the art. For example one configuration includes a rigid support encapsulated within the elastomeric material such as shown and described in commonly-owned U.S. Pat. No. 4,951,418, the details of which are incorporated herein by reference. Still further, commonly-owned provisional application Ser. No. 60/561,972, filed Apr. 14, 2004, illustrates a rigid channel in which a thermoplastic elastomer, such as a thermoplastic vulcanizate (TPV), is provided on the outer edges of the rigid channel and further defines inwardly extending, flexible lips that engage opposite faces of the window.

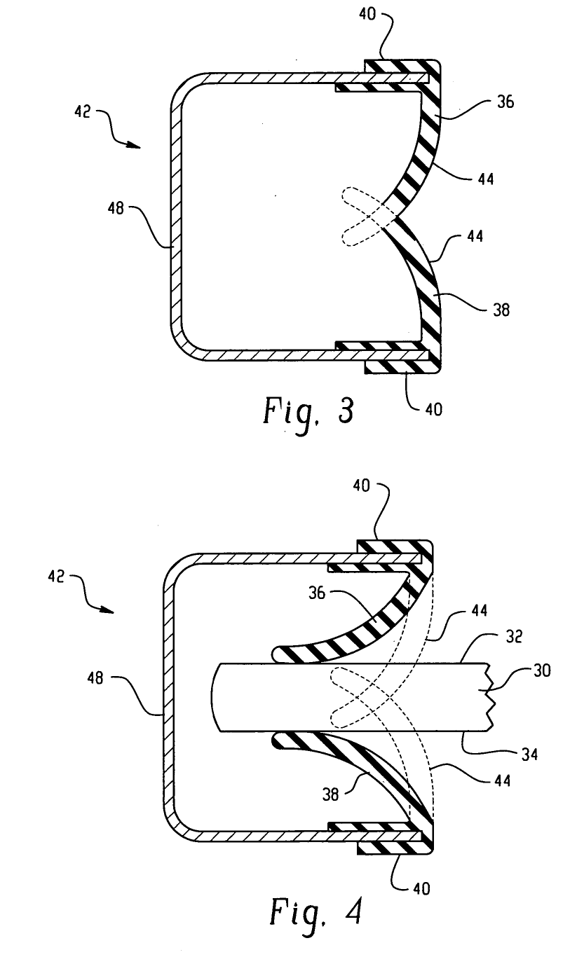

Receipt of the window between the flexible lips is illustrated in FIGS. 3 and 4. The window 30 has first and second surfaces 32, 34 that are respectively engaged by weatherstrips or flexible lips 36, 38. First ends 40 of the lips are secured to outer terminal ends of rigid C-shaped channel 42. A low-friction material 44 is provided on one of the surfaces of the lips 36, 38, namely, the surface disposed for engagement with the window (FIG. 4). It is also known to incorporate the same or a different low-friction material 48 on a base surface of the channel to provide a hard wear surface capable of withstanding repeated contact by the window.

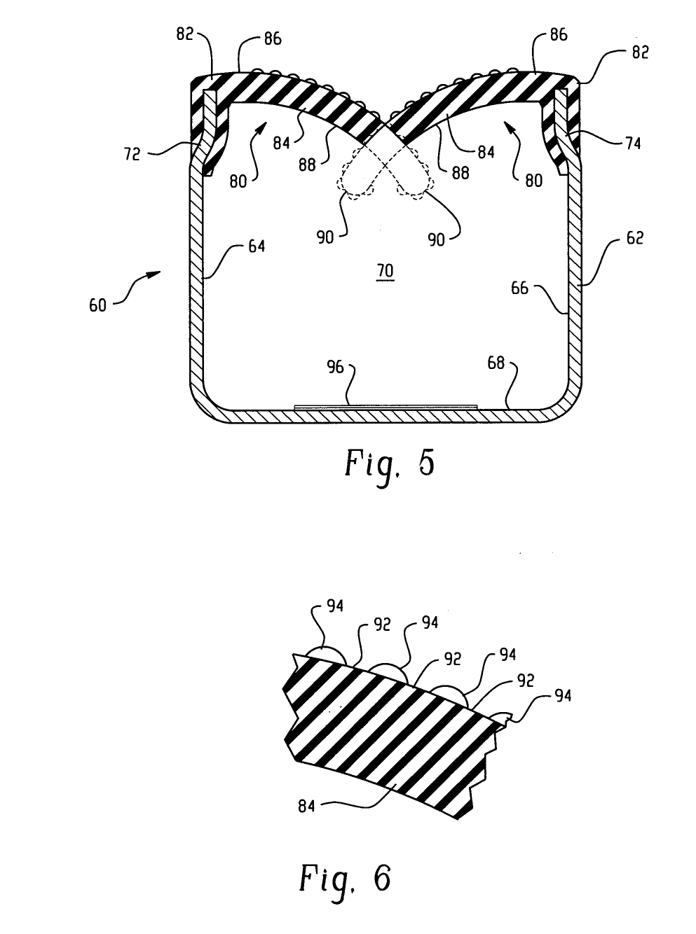

As shown in FIGS. 5 and 6, the weatherstrip of the present invention is shown in greater detail. Here, the weatherstrip is illustrated as a glass run 60 that includes a rigid channel 62 having first and second legs 64, 66 interconnected by a base 68. Typically the channel defined by the legs 64, 66 and interconnecting base 68 is formed from a single material that is formed into the channel configuration and defines an internal cavity 70. Outer terminal ends of the legs include flexible lips or weatherstrips 80, shown here as left and right weatherstrips of substantially the same configuration. It will be understood, however, that the lips may be of a different configuration if deemed necessary. A first end 82 of each seal lip is secured to the outer end of a respective leg of the channel. In the preferred arrangement, the seal lip is extruded over the outer terminal ends of the channel legs without the need for an additional adhesive or other securing means. Although preferred, the invention should not be limited to only an extruded arrangement for securing the weatherstrips to the remainder of the glass run assembly.

Each weatherstrip or flexible lip includes a first elongated flexible member 84 having a first or outwardly extending surface 86 and a second or inwardly facing surface 88. The seal lips are thus cantilever mounted and an inner, terminal edge 90 is free to flex or pivot relative to the mounting region of the first end 82. As will be appreciated from a review of FIGS. 3 and 4, it is desirable to maintain flexibility of the seal lip in the glass run assembly. Inclusion of a coating such as a thermoplastic that serves as a hard, low-friction material provides the desired increased wear characteristics of the seal lips, but unfortunately limits the flexibility of the composite structure. For example, if a coating of greater than 40 to 60 microns (0.040-0.60 mm) is provided on the flexible member, the desired flexibility to conform with the surface of the window may be impacted. On the other hand, an increased amount of the low friction material is desirable to improve durability and wear characteristics.

The present invention as exhibited in the preferred embodiment achieves both flexibility and wearability by providing a space or gap 92 between regions 94 of the low-friction material. In the preferred arrangement, the low-friction material is extruded as longitudinal rows on the first surface of the flexible member. Thus, the flexible member is preferably formed of an elastomeric material, such as rubber or EPDM, because of the desired flexibility characteristics. The low-friction material, on the other hand, is a thermoplastic or other material and is preferably coextruded on the flexible member. Longitudinally extending ridges are separated by gaps of no low-friction material, whereby the seal lip can still flex in these regions absent of any low-friction material. Advantageously, the thickness of the low-friction material coextruded on the first surface of the flexible member can be substantially increased. For example, the thickness may be increased up to a thickness on the order of one hundred twenty microns (0.120 mm). The increased thickness substantially increases the wearability of the seal lips and yet the same flexibility is maintained with the present invention because of the gaps provided between the rows of low-friction material.

As perhaps best exemplified in FIG. 6, the configuration of the low-friction material may have a maximum height, and that height may vary over the cross-section of the ridge of low-friction material. The particular shape or configuration of this low-friction material, however, may vary as deemed necessary. Likewise, the center-to-center spacing between the ridges of low-friction material may vary.

Referring again to FIG. 5, the ridges are preferably provided inwardly from the mounting ends 82 of the lip. The ridges preferably extend over a major portion of the first surface 86 of the flexible member in a continuous, repeatable pattern and may even extend around the inner terminal edge 90 to assure that the low-friction material contacts the surface of the window rather than the elastomer typically forming the flexible member and which would otherwise impart undesired drag forces on the window. Whereas the prior art may use a flexible member having a hardness in the range of 50 Shore A to 80 Shore D and a coating having a hardness on the order of 40 Shore D, flexibility becomes a problem so that it becomes necessary to reduce the thickness of the coating. On the other hand, if the material thickness is reduced, it is difficult to satisfy the wear characteristics required by the OEM. Here, the peaks or ridges provide the desired durability, and the valleys or areas absent of the low friction material provide the flexibility. Design characteristics of the compression load deflection requirement will dictate which regions of the first surface receive the areas of low-friction material.

As noted, a preferred manner of forming the assembly is to co-extrude the flexible member and the low-friction material, and preferably the low-friction material is not a coating; rather the second material is only applied on selected regions of the first material. Because of the ease with which the materials may be co-extruded, it will be appreciated that the low-friction material will typically extend in longitudinal rows that are spaced apart on the first surface of the flexible member. This should not, however, preclude the application of low-friction materials in other manners, e.g., discontinuous rows via molding, etc.

Moreover, the particular material used as the low friction material or thermoplastic material can also be wide ranging. For example, thermoplastics, thermosets, TPEs or UHMW polyethylene are materials that exhibit suitable hardness and also exhibit the desired low-friction are suitable. It is also contemplated that the low-friction material may include particles that provide a sufficient roughness that also reduces friction between the seal lip and the window.

As noted above, this invention should not be limited to just a glass run, but may also find application in other areas, whether they be dynamic or static engagement with a window or other surface. Thus, use in a glass run is evident from this description but should not so limit the claims since it is understood by one skilled in the art that use as a belt seal and in other regions where desired characteristics of a hard surface having low friction can be combined with a flexible nature desired of the underlying flexible material. It will also be appreciated that the low-friction material 96 provided on the base surface 68 of the glass run channel need not incorporate these features because flexibility is not a primary concern. However, application of a hard material in elongated strips or regions having gaps or spaced therebetween can still be supplied by reaching a desired thickness with a lesser amount of the low-friction material and thereby resulting in an overall reduction in the amount of low-friction material used in the component.

Still another example of use of the present invention relates to a door seal or primary seal having a trim lip associated with the seal. The trim lip typically extends over a scuff plate, header, etc. to provide a neat, aesthetically pleasing appearance. With increased use of side air bags, it is desirable to reduce the coefficient of friction associated with the trim lip and maintain the flexibility of the trim lip so as not to adversely impinge on deployment of the air bag. By incorporating the low friction material on a trim lip, the desired characteristics of a hard surface low friction surface that is advantageously flexible to meet the contours of the interior trim are satisfied. Likewise, ease of manufacture is still present, particularly where the primary seal and trim lip are co-extruded, and the low friction material can be co-extruded in longitudinal rows over a desired portion of the trim lip.

The invention has been described with reference to the preferred embodiments. Of course, modifications and alterations will become apparent to those of ordinary skill in the art, and the invention should not be limited to the described embodiments.

Having thus described the invention, it is now claimed:

1. A weather strip for engaging an associated sealing surface comprising:
an elongated flexible member having a first surface, at least a portion of which, is adapted for engagement with the associated window; and
the first surface including a low friction material disposed thereon in longitudinal rows such that the flexible member is capable of selective articulation along a region between the longitudinal rows.

2. The weather strip of claim 1 wherein the flexible member is formed from an elastomeric material.

3. The weather strip of claim 1 wherein the low friction material is one of a thermoplastic and a cross linked thermoplastic.

4. The weather strip of claim 1 wherein the longitudinal rows are substantially parallel along the length of the flexible member.

5. The weather strip of claim 1 wherein the low friction material extends in continuous rows along the first surface portion.

6. The weather strip of claim 5 wherein the rows of low friction material are continuous along the elongated flexible member.

7. The weather strip of claim 6 wherein the rows of low friction material extend outwardly from the first surface of the flexible member.

8. The weather strip of claim 1 wherein the low friction material has a variable thickness over a lateral cross-sectional extent.

9. The weather strip of claim 1 wherein the rows of low friction material extend over substantially all of the first surface.

10. The weather strip of claim 1 wherein the low friction material proceeds over only the first surface portion of the flexible member.

11. A weather strip for engaging an associated sealing surface comprising:
an elongated flexible member having a first surface adapted for sealing engagement with the associated window; and
the first surface including a low friction material of variable thickness disposed on the first surface such that the flexible member maintains flexibility between regions of thick low friction material.

12. The weather strip of claim 11 wherein the low friction material is a thermoplastic.

13. The weather strip of claim 11 wherein the low friction material is disposed in continuous rows extending along the length of the flexible member.

14. The weather strip of claim 11 wherein the low friction material is disposed in segregated rows along an exterior surface of the flexible member that faces the associated glass.

15. The weather strip of claim 11 wherein the low friction material has a maximum thickness on the order of 0.144 mm.

16. A method of forming a weather strip comprising the steps of:
forming an elongated flexible member having a first surface; and
extruding at least first and second rows of a low friction material along the first surface in regions where the weather strip is adapted for engagement with a window surface.

17. The method of claim 16 wherein the flexible member forming step includes the step of extruding the flexible member.

18. The method of claim 16 wherein the flexible member forming step includes the step of co-extruding the flexible member with the low friction material.

19. The method of claim 16 wherein the low friction material extruding step includes spacing the rows apart to allow the weather strip to articulate in regions absent of the low friction material.

20. The method of claim 16 wherein the low friction material extruding step includes the step of continuously extruding the low friction material along an entire length of the first surface.

21. The weather strip of claim 1 wherein the flexible member is a belt seal adapted for mounting on an associated motor vehicle.

22. The weather strip of claim 1 wherein a glass run assembly includes a generally U-shaped channel forming a cavity adapted to receive an edge of an associated window, the flexible member including first and second lips secured to the channel and extending into the cavity, and the low friction material is provided on portions of each of the first and second lips.
